(19) United States
(12) Patent Application Publication
(10) Pub. No.: US 2025/0200388 A1
(43) Pub. Date: Jun. 19, 2025

(54) SYSTEM AND METHOD FOR TRAINING PHYSICS-INFORMED OPERATOR WITH DUAL HYPERNETWORK MODULE AND LOW-RANK DOMAIN DECOMPOSITION

(71) Applicant: Quantiphi, Inc., Marlborough, MA (US)

(72) Inventors: Dagnachew Birru, Marlborough, MA (US); Milad Ramezankhani, Toronto, Ontario (CA); Rishi Yash Parekh, Mumbai (IN); Anirudh Deodhar, Mumbai (IN)

(21) Appl. No.: 19/064,430

(22) Filed: Feb. 26, 2025

Related U.S. Application Data
(63) Continuation-in-part of application No. 18/656,366, filed on May 6, 2024.

(51) Int. Cl. G06N 3/0985; G06N 3/04

(52) U.S. Cl. CPC G06N 3/0985; G06N 3/04

(57) ABSTRACT

A method and system for training physics-informed operators with dual hypernetwork module and low-rank domain decomposition. The method includes identifying availability of information related to system behavior and geometry complexity. The method further includes dynamically determining training strategy for the PINO based on the identification. The training strategy includes at least one of a soft domain decomposition process or a hard domain decomposition process. The method includes determining whether a size of a hypernetwork output layer exceeds a first predefined threshold. The method includes generating a set of training points if the size does not exceed the first predefined threshold. The method includes iteratively training the PINO using the determined strategy based on the set of training points until an error falls below a second predefined threshold. The method includes storing a trained model of the PINO with an associated set of parameters when the error falls below the second predefined threshold.

### CROSS-REFERENCE TO RELATED APPLICATION

This application is a Continuation-in-Part of U.S. patent application Ser. No. 18/656,366, filed on May 6, 2024, entitled “System and method for hypernetwork guided domain decomposition in physics-informed neural operators,” which is hereby incorporated by reference in its entirety.

### FIELD OF THE INVENTION

The present disclosure relates to training Physics-Informed Neural Operators (PINO) and, more specifically, to a method and system for training the PINO with dual hypernetwork module and low-rank domain decomposition.

### BACKGROUND OF THE INVENTION

Partial Differential Equations (PDEs) are fundamental tools for modeling and understanding the behavior of complex systems in science and engineering. Traditional numerical solvers, such as finite element methods (FEMs) and finite difference methods (FDMs), solve PDEs by discretizing the domain into finite-dimensional problems. However, solving high-resolution PDEs for large-scale, complex systems often incurs significant computational costs, making these methods infeasible for many real-world applications.

To address this, there has been a shift toward data-driven alternatives that directly learn the underlying solutions from available data without requiring explicit knowledge of the governing PDEs. Operator learning has emerged as a promising paradigm in this space, enabling the learning of unknown mathematical operators that govern PDE systems. These operators, such as Deep Neural Operator (DeepONet), Fourier Neural Operator (FNO), Graph Neural Operator, General Neural Operator Transformer (GNOT), and Operator Transformer (OFormer), map between infinite-dimensional function spaces and can effectively capture complex solution behaviors. Their inherent differentiability makes them well-suited for inverse problems, including design optimization.

While operator learning has demonstrated significant potential, it relies heavily on large datasets for training, which are often unavailable in practical applications. This data dependency can lead to suboptimal generalization and performance. Physics-informed operator learning addresses this limitation by embedding physical laws, initial conditions, and boundary conditions into the training process, enabling fully data-agnostic or hybrid learning. Despite these advantages, physics-informed operator learning faces challenges in convergence, particularly for systems with nonlinear time-varying dynamics, sharp transitions, or long temporal domains.

Domain decomposition methods have been introduced to overcome these challenges by dividing the problem domain into smaller sub-domains, enabling enhanced convergence and accuracy. Approaches like extended PINN (XPINN) and finite basis PINN (FBPINN) have proven effective, particularly for handling complex systems. Notably, FBPINN simplifies the optimization process by avoiding additional loss terms. However, these methods often struggle with high computational costs, scalability issues, and parameter inefficiency when applied to highly nonlinear or high-frequency problems.

Recently, HyperDeepONet (HDON) has been introduced as a more expressive variant of DeepONet, leveraging hypernetworks to infer the parameters of the trunk network. This architecture integrates input function information comprehensively across the network, enabling it to learn highly nonlinear operators more efficiently with fewer parameters. However, even HDON and other operator learning techniques encounter challenges in effectively addressing long temporal domains, discontinuities, and computational inefficiencies.

The parent patent application U.S. patent Ser. No. 18/656,366 disclosed a method and system for hypernetwork guided domain decomposition in the PINOs by leveraging external domain decomposition techniques. This approach significantly improved the learning efficiency and convergence for systems with long temporal domains, discontinuities, and complex geometries.

While the parent invention addressed challenges related to training the PINOs, it relied on domain decomposition as an external, auxiliary component to assist the operator in learning the complex PDE solutions. This external implementation, while effective, increased the model's computational cost and parameter complexity. Moreover, the parent invention lacked an efficient mechanism to optimize the parameter size during decomposition.

The present invention builds upon the concepts introduced in the parent application by integrating built-in domain decomposition functionality directly into the architecture of the neural operator. This built-in approach allows the operator to naturally decompose the domain without relying on external auxiliary mechanisms, improving computational efficiency, and reducing system complexity.

Additionally, the present invention introduces a low-rank adaptation mechanism within the neural operator architecture. This novel feature further reduces the size of the model, promoting a more parameter-efficient training process for operators using domain decomposition. The low-rank adaptation ensures that the number of trainable parameters remains constant across various decomposition levels, addressing scalability issues inherent in prior methods. By embedding domain decomposition functionality and incorporating low-rank adaptation, the present invention significantly enhances the accuracy, scalability, and efficiency of operator training for highly nonlinear, high-frequency, and time-varying PDE systems. These advancements address the limitations of the parent invention and provide a more robust framework for solving complex physical systems using Physics-Informed Neural Operators.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a computer-implemented method for training physics-informed neural operator (PINO) with a dual hypernetwork module and low-rank domain decomposition, the method may include identifying an availability of information related to a system behavior and geometry complexity. The method may further include dynamically determining a training strategy for the PINO based on the identification. The training strategy includes selectively implementing at least one of a soft domain decomposition process or a hard domain decomposition process for training the PINO. The method may further include determining whether a size of a hypernetwork output layer exceeds a first predefined threshold. The method may further include generating a set of training points across each domain, if the hypernetwork output size does not exceed the first predefined threshold. The method may further include iteratively training the PINO using one of the determined training strategy based on the set of training points until an error falls below a second predefined threshold. The method may further include storing a trained model of the PINO with an associated set of parameters in a database when the error falls below the second predefined threshold after the iterative training.

According to some example embodiments, the soft domain decomposition process is implemented using a mixture of experts (MoE) approach.

According to some example embodiments, the hard domain decomposition process is implemented using the dual hypernetwork module and the low-rank domain decomposition (LoRA) technique.

According to some example embodiments, the dual hypernetwork module includes a first hypernetwork configured to co-learn about an unknown solution operator for a complex partial differential equation (PDE) system and a second hypernetwork configured to embed sub-domain information and map the embedded sub-domain information to a feature representation for domain decomposition.

According to some example embodiments, if the size of the hypernetwork output layer exceeds the first predefined threshold, the method further includes reducing the size of the hypernetwork outer layer using a chunked hypernetwork strategy.

According to some example embodiments, if the error does not fall below the second predefined threshold, the method further includes decomposing the domain into a plurality of finer sub-domains and reinitiating the training with the plurality of finer sub-domains in response to a previous iteration.

According to some example embodiments, the set of training points includes initial points, boundary points, collocation points for enforcing physics-informed constraints, and interface points between adjacent sub-domains for maintaining physical continuity.

According to some example embodiments, to dynamically determine the training strategy, the method further includes initializing the training with the soft domain decomposition process when there is no prior availability of information related to the system behavior and geometry complexity.

According to some example embodiments, to dynamically determine the training strategy, the method further includes reinitializing the training with the hard domain decomposition process in response to unsatisfactory results obtained during the soft domain decomposition process.

According to some example embodiments, to implement the hard domain decomposition process, the method further includes identifying a presence of at least one discontinuity and nonlinearity in the system, wherein identification of the presence is at least of a successful identification or an unsuccessful identification.

According to some example embodiments, the method further includes performing at least one of, upon the successful identification of the at least one discontinuity and nonlinearity, decomposing the domain into a plurality of finer sub-domains, or upon the unsuccessful identification of the at least one discontinuity and nonlinearity, decomposing the domain into a plurality of coarser sub-domains.

According to some example embodiments, the method further includes determining at least one irregular geometry and non-uniform sub-domain configuration and generating one or more additional interface points and interface loss terms using an Extended Physics-Informed Neural Network (XPINN) in response to the at least one determined irregular geometry and non-uniform sub-domain configuration to maintain sub-domain continuity.

According to some example embodiments, upon unsuccessful determination of the at least one irregular geometry and non-uniform sub-domain configuration, the method further includes automatically maintaining the sub-domain continuity using a Finite Basis Physics-Informed Neural Network (FBPINN).

According to some example embodiments, to implement the soft domain decomposition process, the method further includes initializing a router module to manage interactions among one or more expert subnetworks.

Some example embodiments disclosed herein provide a computer system for training physics-informed neural operator (PINO) with a dual hypernetwork module and low-rank domain decomposition, the computer system comprising one or more computer processors, one or more computer readable memories, one or more computer readable storage devices, and program instructions stored on the one or more computer readable storage devices for execution by the one or more computer processors via the one or more computer readable memories, the program instructions comprising identifying an availability of information related to a system behavior and geometry complexity. The one or more processors are further configured for dynamically determining a training strategy for the PINO based on the identification. The training strategy includes selectively implementing at least one of a soft domain decomposition process or a hard domain decomposition process for training the PINO. The one or more processors are further configured for determining whether a size of a hypernetwork output layer exceeds a first predefined threshold. The one or more processors are further configured for generating a set of training points across each domain, if the hypernetwork output size does not exceed the first predefined threshold. The one or more processors are further configured for iteratively training the PINO using one of the determined training strategy based on the set of training points until an error falls below a second predefined threshold. The one or more processors are further configured for storing a trained model of the PINO with an associated set of parameters in a database when the error falls below the second predefined threshold after the iterative training.

Some example embodiments disclosed herein provide a non-transitory computer readable medium having stored thereon computer executable instruction which when executed by one or more processors, cause the one or more processors to carry out operations for training physics-informed neural operator (PINO) with a dual hypernetwork module and low-rank domain decomposition, the operations include identifying an availability of information related to a system behavior and geometry complexity. The operations further includes dynamically determining a training strategy for the PINO based on the identification. The training strategy includes selectively implementing at least one of a soft domain decomposition process or a hard domain decomposition process for training the PINO. The operations further include determining whether a size of a hypernetwork output layer exceeds a first predefined threshold. The operations further include generating a set of training points across each domain, if the hypernetwork output size does not exceed the first predefined threshold. The operations further include iteratively training the PINO using one of the determined training strategy based on the set of training points until an error falls below a second predefined threshold. The operations further include storing a trained model of the PINO with an associated set of parameters in a database when the error falls below the second predefined threshold after the iterative training. providing the plurality of sub-domain identifiers as an input to a hypernetwork.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system training physics-informed neural operator (PINO) with a dual hypernetwork module and low-rank domain decomposition, in accordance with an example embodiment.

FIG. 2 is a block diagram illustrating various modules within a memory of a computing device configured for training the PINO with the dual hypernetwork module and low-rank domain decomposition, in accordance with an example embodiment.

FIG. 3 illustrates a flow diagram of a method for training the PINO with the dual hypernetwork module and low-rank domain decomposition, in accordance with an example embodiment.

FIG. 4 illustrates an exemplary process flow for training the PINO, in accordance with an example embodiment.

FIG. 5 illustrates a schematic diagram for training the PINO with the dual hypernetwork module and low-rank domain decomposition, in accordance with an example embodiment.

FIG. 6 illustrates a schematic diagram for training the PINO with a single hypernetwork module and a mixture of experts, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Physics-Informed Neural Operators (PINOs)” may represent a type of machine learning framework that combines principles from physics with neural network architectures, for mapping relationships between functional spaces. These PINOs are utilized for modeling complex systems, particularly those characterized by nonlinear dynamics, long temporal domains, and discontinuities.

The term “hypernetwork” may refer to a type of neural network architecture used in machine learning. A hypernetwork is a neural network architecture that, given a set of input configurations, generates the corresponding weights for another network often referred to as the primary network.

The term “machine learning model” may be used to refer to a computational or statistical or mathematical model that is trained on classical ML modelling techniques with or without classical image processing. The “machine learning model” is trained over a set of data and using an algorithm that it may be used to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “dual hypernetwork module” may refer to an architectural component consisting of two distinct hypernetworks designed to operate in tandem, where one hypernetwork specializes in learning an unknown solution operator for a partial differential equation (PDE), and the other manages temporal domain decomposition. This configuration ensures efficient learning of complex, high-dimensional systems with coupled dynamics.

The term “low-rank adaptation” may refer to a technique that optimizes the parameter space of a neural network by decomposing the weight matrices into low-rank structures. This technique reduces the size and computational complexity of the model while retaining its accuracy, particularly for domain decomposition tasks.

The term “domain decomposition” may refer to the process of dividing the problem domain of a partial differential equation (PDE) into smaller subdomains to simplify the training process of machine learning models, particularly neural operators. Domain decomposition may involve spatial, temporal, or both types of partitions depending on the complexity of the problem.

The term “finite basis physics-informed neural operator” (FB-PINO) may represent a variant of PINOs that employs a finite basis to approximate solutions to PDEs. This variant simplifies the optimization process by reducing the dimensionality of the function space, making it suitable for high-frequency and nonlinear problems.

The term “operator learning” may refer to a machine learning framework designed to learn mappings between infinite-dimensional function spaces, such as those defined by the solution operator of a partial differential equation. Operator learning aims to approximate the underlying mathematical operator governing a system.

The term “built-in domain decomposition functionality” may refer to a feature integrated directly within the architecture of a neural operator, enabling the operator to perform domain decomposition inherently without requiring external auxiliary mechanisms.

The term “neural operator” may refer to a class of deep learning architectures that map between infinite-dimensional spaces, specifically for solving problems in functional analysis, partial differential equations, and other domains requiring high-dimensional approximations.

The term “parameter-efficient architecture” may refer to a machine learning architecture designed to minimize the number of trainable parameters while maintaining or improving model performance. This approach often employs techniques such as weight sharing, low-rank adaptations, or hypernetworks.

The term “complex geometries” may refer to domains or systems characterized by irregular shapes, discontinuities, or intricate structures that pose challenges for numerical simulations and machine learning-based approaches.

### End of Definitions

As described earlier, PINOs have emerged as a powerful tool for simulating physical systems. However, training PINOs for complex systems, particularly those with long temporal domains and discontinuities, presents significant challenges. The inherent limitations inherited from Physics-Informed Neural Networks (PINNs) often lead to failure in achieving acceptable accuracies when learning such systems. Domain decomposition has been introduced as a solution for training PINOs. By dividing the problem domain into smaller sub-domains, each of which can be solved independently, domain decomposition may significantly improve the convergence and accuracy of PINOs. However, this approach often leads to high computational costs as multiple neural networks must be trained simultaneously or sequentially. Furthermore, determining the appropriate size and number of subdomains for each application lacks an optimal and efficient strategy. To overcome these shortcomings, the present invention discloses a dual-hypernetwork module and a low-rank domain decomposition framework. The dual-hypernetwork module incorporates two specialized hypernetworks: one to generate feature representations for sub-domains and another to learn the unknown solution operator for the system. These hypernetworks are dynamically linked through operations like the low-rank adaptation to enable parameter-efficient domain decomposition. Additionally, the incorporation of a low-rank adaptation (LoRA) technique minimizes the number of trainable parameters, thereby enabling fine-grained domain decomposition with reduced computational burden.

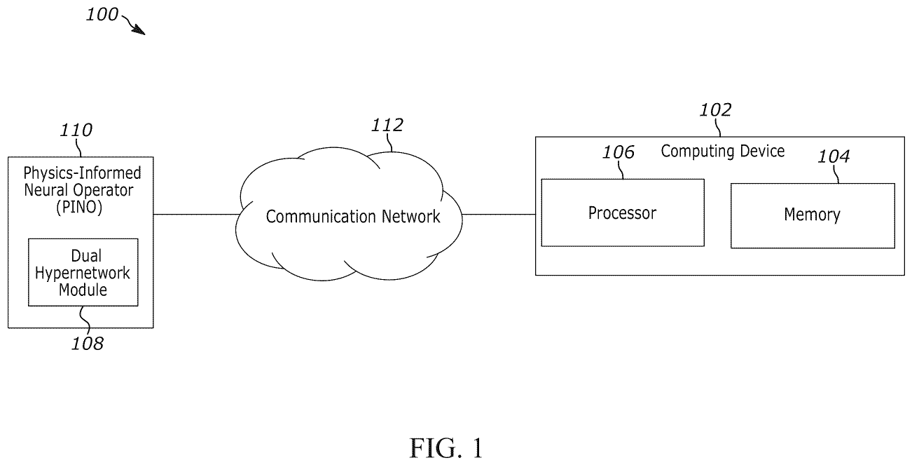

Embodiments of the present disclosure may provide a method, a system, and a computer program product for training the PINO with the dual hypernetwork module and low-rank domain decomposition. The method, the system, and the computer program product performing training of the PINO in such an improved manner are described with reference to FIG. 1 to FIG. 6 as detailed below.

FIG. 1 illustrates a block diagram of an environment of a system 100 for training PINO with the dual hypernetwork module and low-rank domain decomposition, in accordance with an example embodiment. The system 100 includes a computing device 102, a PINO 110, and a dual hypernetwork module 108 embedded within the PINO 110. The computing device 102 may be communicatively coupled with the dual hypernetwork module 108 and the PINO 110 via a communication network 112. Examples of the computing device 102 may include, but are not limited to, a server, a desktop, a laptop, a notebook, a tablet, a smartphone, a mobile phone, an application server, or the like.

The communication network 112 may be wired, wireless, or any combination of wired and wireless communication networks, such as cellular, Wi-Fi, internet, local area networks, or the like. In one embodiment, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 104, and a processor 106. The term “memory” used herein may refer to any computer-readable storage medium, for example, volatile memory, random access memory (RAM), non-volatile memory, read only memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining, and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

The computing device 102 may be capable of training the PINO 110 with the dual hypernetwork module 108 and low-rank domain decomposition. The memory 104 may store instructions that, when executed by the processor 106, cause the computing device 102 to perform one or more operations. For example, the computing device 102 may identify an availability of information related to a system behavior and geometry complexity. Based on the identification, the computing device 102 may dynamically determine a training strategy for the PINO 110 based on the identification. The training strategy comprises selectively implementing at least one of a soft domain decomposition process or a hard domain decomposition process for training the PINO 110.

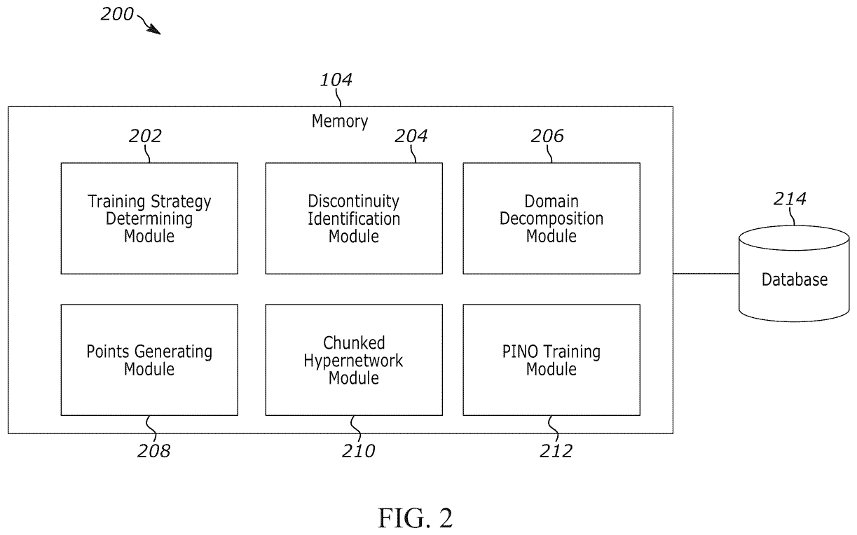

The computing device 102 may further determine whether a size of a hypernetwork output layer exceeds a first predefined threshold. If the size does not exceed the first predefined threshold, the computing device 102 may generate a set of training points across each domain. Further, the computing device 102 may iteratively train the PINO using one of the determined training strategy based on the set of training points until an error falls below a second predefined threshold. The computing device 102 may further store a trained model of the PINO with an associated set of parameters in a database when the error falls below the second predefined threshold after the iterative training. The complete process followed by the system 100 is explained in detail in conjunction with FIG. 2 to FIG. 6.

FIG. 2 illustrates a block diagram 200 illustrating various modules within the memory 104 of the computing device 102 configured for training the PINO with a dual hypernetwork module and low-rank domain decomposition, in accordance with an example embodiment. The memory 104 may include a training strategy determining module 202, a discontinuity identification module 204, a domain decomposition module 206, a points generating module 208, a chunked hypernetwork module 210, and a PINO training module 212.

To perform training of the PINO, initially, the training strategy determining module 202 may dynamically determine a training strategy for the PINO based on the availability of system behavior information and geometry complexity. In an embodiment, the system behavior may refer to the characteristics of the physical system under consideration, such as continuity, nonlinearity, or the presence of abrupt changes (discontinuities). For example, turbulent fluid flow or shock waves in aerodynamics would signify a complex system behavior. Further, the geometry complexity may refer to the structural or spatial configuration of the domain, such as irregular shapes, multi-scale patterns, or non-uniform sub-domains. For instance, porous materials with intricate microstructures require a more sophisticated approach.

The training strategy may include selectively implementing at least one of a soft domain decomposition process or a hard domain decomposition process for training the PINO. For example, when there is no prior information related to the system behavior and geometry complexity, the training strategy determining module 202 may initialize training with the soft domain decomposition process. In an embodiment, implementing the soft domain decomposition process comprises initializing a router module to manage interactions among one or more expert subnetworks. In an embodiment, the soft domain decomposition process is implemented using a mixture of experts (MoE) approach.

The MoE approach is a machine learning technique designed to enhance model performance by dividing complex tasks among specialized subnetworks, referred to as “experts.” Each expert is responsible for handling a specific portion of the domain or problem, while the router module dynamically assigns input data to the most appropriate expert(s) based on certain criteria, such as system behavior or geometry complexity. This modular structure allows the MoE to adaptively learn and process domain information, improving efficiency and scalability. Unlike hard domain decomposition, where each expert is explicitly assigned to a fixed sub-domain, the soft domain decomposition strategy does not rely on explicit sub-domains. Instead, the router determines the experts involved in the prediction for each test point, meaning that an expert can be engaged in predicting a large portion of the domain as needed. By enabling parallel training of experts and leveraging their collective expertise, the MoE approach is particularly well-suited for the soft domain decomposition process.

Further, the training strategy determining module 202 may reinitialize the training with the hard domain decomposition process in response to unsatisfactory results obtained during the soft domain decomposition process. In other words, after the initial training, if a satisfactory result is not achieved (e.g., low accuracy), the training process can be repeated with the hard domain decomposition process, leveraging the knowledge achieved during the initial training phase. In an embodiment, the hard domain decomposition process is implemented using the dual hypernetwork module and the low-rank domain decomposition (LoRA) technique.

In an embodiment, the dual hypernetwork module may include a first hypernetwork (e.g., operator hypernet ho) configured to co-learn an unknown solution operator for a complex partial differential equation (PDE) system. The dual hypernetwork module may further include a second hypernetwork (e.g., domain hypernet hp) configured to embed sub-domain (e.g., bounds coordinates) and map it to feature representation effectively to perform domain decomposition. The present disclosure provides a built-in domain decomposition capability, which is accomplished by integrating the outputs of the hypernetworks via a low-rank adaptation operation which results in the parameters of a target network. This provides a unique framework for effectively training the PINO for complex PDE systems via parameter-efficient domain decomposition. Further, the domain decomposition process incorporates the LoRA technique within the hypernetwork framework. The LoRA technique is configured to further reduce the number of trainable parameters for generating subdomains' parameters, particularly in cases requiring fine-grained domain decomposition, by adapting the hypernetwork layers to low-rank structures and optimize the computational efficiency and memory usage while preserving the accuracy of the PINO for complex PDE systems.

The LoRA technique is an optimization method used to efficiently manage complex, high-dimensional computations by reducing the rank of parameter matrices in neural networks. In the hard domain decomposition, LoRA facilitates the training process by decomposing the computational domain into smaller sub-domains (e.g., overlapping, or non-overlapping sub-domains, depending on whether the FBPINN or XPINN framework is employed), while representing the domain-specific features in a low-dimensional space. This dimensionality reduction minimizes memory and computational overhead, enabling faster convergence and improved accuracy. By focusing on learning the most significant parameters within the network, LoRA helps maintain the fidelity of the solution while optimizing resource utilization. When paired with the dual hypernetwork module, LoRA ensures robust embedding of sub-domain information, making it highly effective in addressing systems with complex geometries, discontinuities, or nonlinearities. This combination enhances the model's ability to co-learn across multiple sub-domains while maintaining computational efficiency.

In an embodiment, when the hard domain decomposition process is implemented, the discontinuity identification module 204 may identify the presence of at least one discontinuity (e.g., sudden changes in geometry parameters or sharp change in boundary condition) and nonlinearity characteristics in the system. Identification of the presence is at least one of a successful identification or an unsuccessful identification.

In an embodiment, upon the successful identification of the at least one discontinuity and nonlinearity, the domain decomposition module 206 may decompose the domain into a plurality of finer sub-domains (n_{fine}). In an alternative embodiment, upon the unsuccessful identification of the at least one discontinuity and nonlinearity, the domain decomposition module 206 may decompose the domain into a plurality of coarser sub-domains (n_{coarse}).

Further, the discontinuity identification module 204 may determine at least one irregular geometry and non-uniform sub-domain configuration. An Extended Physics-Informed Neural Network (XPINN) may be implemented upon determining at least one irregular geometry and non-uniform sub-domain configuration. For the XPINN, one or more additional interface points and interface loss terms may be generated to maintain sub-domain continuity.

Upon unsuccessful determination of the at least one irregular geometry and non-uniform sub-domain configuration, a Finite Basis Physics-Informed Neural Network (FBPINN) may be implemented. The FBPINN may automatically maintain the sub-domain continuity and information flow.

Further, a check is performed to determine whether a size of a hypernetwork output layer exceeds a first predefined threshold (e.g., beyond mₘₐₓ). In an embodiment, if the size does not exceed the first predefined threshold, the points generating module 208 may generate a set of training points across each domain. The set of training points comprises initial points, boundary points, collocation points for enforcing physics-informed constraints, and interface points between adjacent sub-domains for maintaining physical continuity. In an embodiment, if the size of the hypernetwork output layer exceeds the first predefined threshold, the chunked hypernetwork module 210 may reduce the size of the hypernetwork outer layer using a chunked hypernetwork strategy. In the chunking strategy, the weights of the target network are generated in chunks, through iterative forward passes of hypernetwork which significantly reduces the size of the hypernetwork output layer and the overall parameter count.

Further, the PINO training module 212 may iteratively train the PINO using one of the determined training strategy based on the set of training points until an error falls below a second predefined threshold. In an embodiment, if the error does not fall below the second predefined threshold, the domain decomposition module 206 may decompose the domain into a plurality of finer sub-domains and reinitiating the training with the plurality of finer sub-domains in response to a previous iteration. Furthermore, a database 214 is configured to store a trained model of the PINO with an associated set of parameters (e.g., sub-domain definitions and hypernetwork parameters) when the error falls below the second predefined threshold after the iterative training. The trained model may be used to solve problems in fields such as fluid dynamics, material mechanics, PDE, or multi-physics systems characterized by nonlinearity or complex geometries.

In an overall aspect, the present disclosure utilizes hypernetwork and LoRA to incorporate built-in domain decomposition by generating low-rank matrices that embed the effect of each subdomain in the target network.

The present disclosure utilizes a single hypernetwork to represent all subdomains in a highly efficient manner using low-rank adaptation, significantly reducing the number of overall trainable parameters.

The present disclosure automatically decides whether to use soft (via mixture of experts (MoE)) or hard (via hypernetworks and LoRA) domain decomposition based on the complexity of the problem at hand and the available information about the system behavior.

The present disclosure enables neural operators to efficiently learn nonlinearities and discontinuities in complex systems and geometries with significantly less trainable parameters and computational costs.

The present disclosure enables digital twin systems in complex real-world scenarios to be equipped with accurate and accelerated predictive capabilities without the need for data collection through the unified physics-informed operator powered by built-in parameter-efficient domain decomposition.

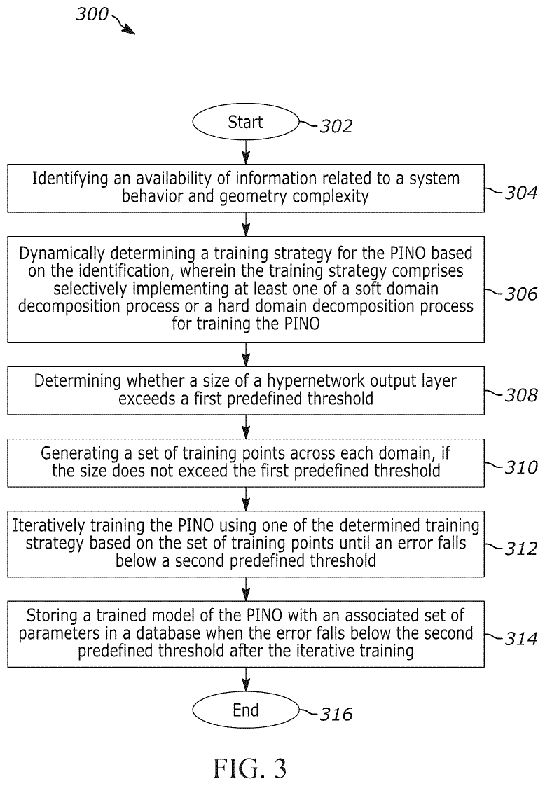

FIG. 3 illustrates a flow diagram of a method 300 for training the PINO with the dual hypernetwork module and low-rank domain decomposition, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 300 illustrated by the flow diagram of FIG. 3 for training the PINO may start at step 302. Further, the method 300 may include identifying an availability of information related to a system behavior and geometry complexity, at step 304.

The method 300, at step 306, may include dynamically determining a training strategy for the PINO based on the identification. The training strategy includes selectively implementing at least one of a soft domain decomposition process or a hard domain decomposition process for training the PINO.

In some embodiments, to dynamically determine the training strategy, the method 300 includes initializing the training with the soft domain decomposition process when there is no prior availability of information related to the system behavior and geometry complexity. In some embodiments, to dynamically determine the training strategy, the method 300 includes reinitializing the training with the hard domain decomposition process in response to unsatisfactory results obtained during the soft domain decomposition.

In an embodiment, the soft domain decomposition process is implemented using the MoE approach. In an embodiment, to implement the soft domain decomposition process, the method 300 further includes initializing a router module to manage interactions among one or more expert subnetworks. In an embodiment, the hard domain decomposition process is implemented using the dual hypernetwork module and the low-rank domain decomposition (LoRA) technique. The dual hypernetwork module may include a first hypernetwork and a second hypernetwork. The first hypernetwork configured to co-learn an unknown solution operator for the complex PDE system. The second hypernetwork is configured to embed sub-domain information and map the embedded sub-domain information to a feature representation for domain decomposition.

At step 308, the method 300 may include determining whether a size of a hypernetwork output layer exceeds a first predefined threshold. In an embodiment, if the size of the hypernetwork output layer exceeds the first predefined threshold, the method 300 may include reducing the size of the hypernetwork outer layer using a chunked hypernetwork strategy.

At step 310, the method 300 may include generating a set of training points across each domain if the size does not exceed the first predefined threshold. The set of training points may include initial points, boundary points, collocation points for enforcing physics-informed constraints, and interface points between adjacent sub-domains for maintaining physical continuity.

At step 312, the method 300 may include iteratively training the PINO using one of the determined training strategy based on the set of training points until an error falls below a second predefined threshold. In an embodiment, if the error does not fall below the second predefined threshold, the method 300 includes decomposing the domain into a plurality of finer sub-domains and reinitiating the training with the plurality of finer sub-domains in response to a previous iteration.

At step 314, the method 300 may include storing a trained model of the PINO with an associated set of parameters in a database when the error falls below the second predefined threshold after the iterative training. Further, the method 300 terminated at step 316.

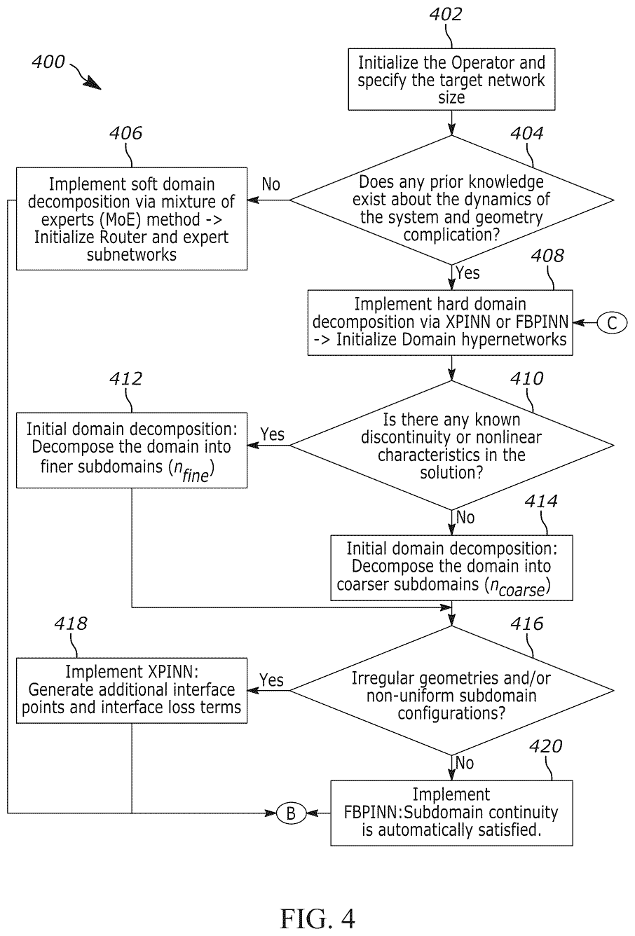

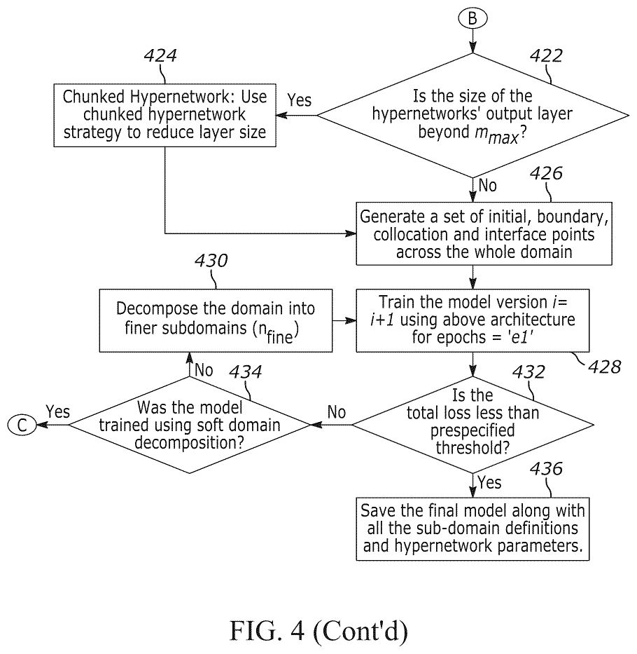

FIG. 4 illustrates an exemplary process flow 400 for training the PINO with the dual hypernetwork module and low-rank domain decomposition, in accordance with an example embodiment. The process flow 400 begins with step 402, where the operator initializes the system and specifies the target network size. This initialization phase sets the foundation for training the PINO by defining the scope of the network and its intended applications.

At step 404, the process flow 400 determines whether prior knowledge exists about the dynamics of the system behavior and the complexity of the geometry. If no prior knowledge is available, the process flow 400 proceeds to step 406, where the soft domain decomposition process is implemented using a Mixture of Experts (MoE) approach. Here, a router module initializes and manages interactions among expert subnetworks, which collaboratively learn about the system behavior in the absence of the prior information.

If prior knowledge about system dynamics and geometry complexity is available, the process moves to step 408, where the hard domain decomposition process is implemented. This involves leveraging either the XPINN or the FBPINN to initialize domain hypernetworks. These hypernetworks facilitate effective learning in systems with known complexities, such as discontinuities or nonlinearities.

From here, the process flow 400 examines the nature of the domain in step 410. If discontinuities or nonlinear characteristics are identified, the domain is decomposed into finer subdomains (n_{fine}) in step 412. However, if no such characteristics are present, the domain is decomposed into coarser subdomains (n_{coarse}) in step 414, ensuring efficient computation by minimizing the granularity of the subdomain partitioning.

Next, in step 416, the process flow 400 checks for irregular geometries or non-uniform subdomain configurations. If such conditions are detected, step 418 involves implementing XPINN to generate additional interface points and interface loss terms. These components are essential for maintaining continuity and accuracy across subdomains, particularly in the presence of irregular geometries.

If no irregularities are found, the process defaults to step 420, where FBPINN is utilized to automatically ensure subdomain continuity. The FBPINN approach allows for seamless integration of subdomains without the need for additional interface adjustments.

At step 422, the process flow 400 evaluates whether the size of the hypernetworks' output layer exceed a first predefined threshold. If the size exceed this threshold, the process flow 400 proceeds to step 424, where a chunked hypernetwork strategy is employed. This approach reduces the dimensionality of the output layer by dividing the hypernetwork into manageable chunks, ensuring computational efficiency and scalability.

If the output layer sizes do not exceed the first predefined threshold, the process flow moves to step 426. At step 426, a set of training points (e.g., initial, boundary, collocation, and interface points) is generated across the entire domain. These training points form the basis for defining and evaluating the subdomains and their interfaces.

In step 428, the model (e.g., version i=i+1) is trained using the above-defined architecture for a specified number of epochs=‘e1’. This iterative process ensures that the network learns the underlying system dynamics effectively.

If the loss is not below the threshold, the process flow 400 moves to step 730, where the domain is decomposed into finer subdomains (n_{fine}), further refining the granularity to capture complex dynamics.

At step 432, the process flow 400 checks whether the total loss during training is below a prespecified threshold. If the loss is not within acceptable limits (e.g., a second predefined threshold), the process flow 400 then moves to step 734, where it determines whether the model was trained using the soft domain decomposition approach. If soft domain decomposition was employed, the process returns to step C.

If the loss is within acceptable limits, the process flow 400 moves to step 436, where the final model is saved. This includes saving the subdomain definitions and the hypernetwork parameters, ensuring the trained model is ready for deployment.

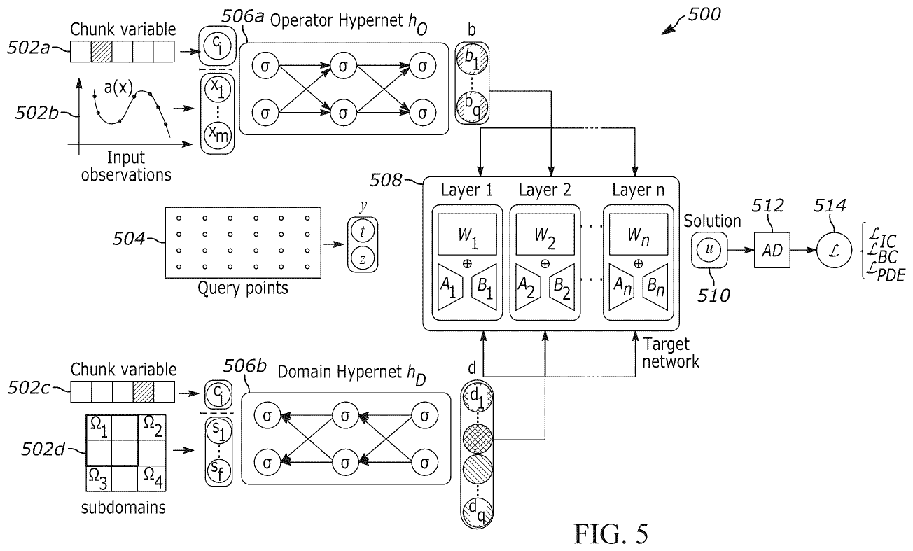

FIG. 5 illustrates a schematic diagram 500 for training the PINO model architecture with the dual hypernetwork module and low-rank domain decomposition (e.g., hard domain decomposition process), in accordance with an example embodiment. The present PINO architecture consists of a dual hypernetwork module, i.e., an Operator Hypernet (h_{O}) and a Domain Hypernet (h_{D}) with equal output dimensions, which work in conjunction to parameterize the target network.

The Operator hypernet h_{O} is responsible for mapping the input function observations 502b, denoted as [a(x₁), a(x₂), . . . , a(xₘ)] at sensor points to a feature representation [b₁, b₂, . . . , b_{q}]^{T}. Domain hypernet hp, on the other hand, takes in the subdomain 502d coordinates [s₁, s₂, . . . , s_{f}]^{T} as the input and generates a feature embedding d. The hypernets' outputs are then merged via the low-rank adaptation operation, generating the weights of the target network.

Query points 504 are spatiotemporal coordinates (t, z) that define the points where the solution of the governing physics-informed problem is computed. To handle the challenge of large output layers, a chunking mechanism 502a, 502c is employed by both hypernetworks ho and hp. This mechanism divides the network parameters into smaller, manageable chunks, facilitating efficient generation of target network weights. Chunk identifiers C are used to differentiate between specific chunks during this iterative process.

The target network 508 comprises multiple layers (Layer 1, Layer 2, . . . , Layer n), each parameterized by weights generated from the embeddings produced by h_{O} and h_{D}. The embedding b (output of h_{O}) generates the weights (W₁, W₂, . . . . Wₙ) which correspond to the learning of the unknown solution operator for a given system configuration. The embedding d (output of hp), on the other hand, generates the weights of the low-rank matrices (A₁, B₁, A₂, B₂, . . . . Aₙ, Bₙ), responsible for incorporating the effect of each subdomain. These effects can be captured at each layer through a matrix multiplication of the low-rank matrices (ΔW=A×B). The final weights of each layer are then obtained by summing the base weights W with the low-rank adjustment ΔW (also referred to as low-rank adaptation). The target network 508 computes the solution u 510 at query points y. This solution is evaluated against governing physics equations using automatic differentiation (AD) 512, generating physics-informed losses (L_{IC}, L_{BC}, L_{PDE}) 514. These losses drive the training process, updating the hypernetwork parameters to optimize the model's accuracy and adherence to physical laws.

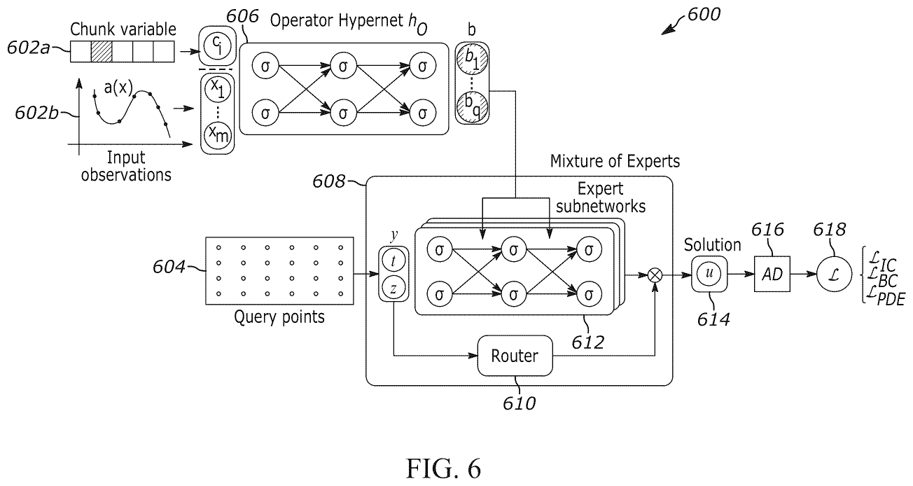

FIG. 6 illustrates a schematic diagram 600 for training the PINO with a single hypernetwork module and a mixture of experts (e.g., soft domain decomposition process), in accordance with another example embodiment. This architecture leverages a single Operator Hypernet ho and an MoE component to improve computational efficiency and solution accuracy.

Input Observations 602b: The model takes input observations [a(x₁), a(x₂), . . . , a(xₘ)], representing the sensor data or measurements at specific spatial points. These are fed into the Operator Hypernet ho, 606, which generates a parameterized representation for the neural operator.

Query Points 604: Spatiotemporal coordinates (t, z) where the solution of the target physics-informed problem is computed are also provided as inputs. These query points define the locations in the domain where the output solution u is required.

Chunk Variable 602a: To handle large-scale computations and manage the weights generated by ho, the Chunk Variable 602a is used. This mechanism divides the network parameters into smaller, manageable chunks, facilitating efficient generation of target network weights. Chunk identifiers C are used to differentiate between specific chunks during this iterative process.

Single Hypernetwork Module: The Operator Hypernet h_{O}, 606 serves as the central hypernetwork that processes the input observations and generates embeddings to parameterize the expert subnetworks in the MoE framework. This single hypernetwork simplifies the architecture by focusing on the operator-level parameterization.

Mixture of Experts (MoE): The MoE Framework 608 introduces modularity and flexibility in the architecture. It consists of a router and Expert Subnetworks. The router directs input embeddings to appropriate expert subnetworks based on learned routing logic, optimizing the utilization of expert networks for specific tasks or regions of the domain. Expert Subnetworks: Multiple expert subnetworks within the MoE are specialized to handle different parts of the solution space. These subnetworks work in parallel to compute solutions for their designated regions or tasks.

Solution Computation: The output of the MoE is the computed solution (u) 614 at the query points. This solution represents the predicted values for the physical system at the specified spatiotemporal coordinates.

Physics-Informed Loss Computation: The model incorporates Automatic Differentiation (AD) 616 to compute derivatives required for the governing physics equations. This enables the enforcement of physical laws during training.

The resulting physics-informed losses (L_{IC}, L_{BC}, L_{PDE}) 618. are used to guide the optimization process, ensuring that the solution adheres to initial conditions, boundary conditions, and the governing PDE.

Therefore, the decision to use the configuration described in FIG. 5 (hard domain decomposition process) or FIG. 6 (soft domain decomposition process) to train the PINO depends on the complexity of the problem, the nature of the solution space, and the level of precision required for adherence to physics constraints. Each configuration is tailored for specific scenarios to optimize performance and computational efficiency.

FIG. 5, representing the hard domain approach, is designed for problems involving complex, discontinuous, or highly localized behaviors within the solution space. This approach leverages a dual hypernetwork module Operator Hypernet ho and Domain Hypernet hp combined with low-rank domain decomposition. The Operator Hypernet processes input observations, while the Domain Hypernet handles subdomain information, and their outputs are integrated via the low-rank adaptation operation to generate the weights of the target network. By partitioning the domain into smaller subdomains and maintaining distinct hypernetwork representations, this configuration ensures precise domain decomposition and high accuracy. The hard domain approach enforces strict adherence to physics constraints, making it particularly suitable for problems requiring localized precision, such as discontinuities, sharp gradients, or complex boundary behaviours, including multiphysics or high-dimensional partial differential equation (PDE) problems.

In contrast, FIG. 6, which illustrates the soft domain approach is ideal for problems where the solution space is relatively smooth and homogeneous. The soft domain decomposition approach may be implemented if the behavior of the system at hand is unknown. This configuration employs a single hypernetwork Operator Hypernet ho in combination with the MoE framework. The MoE module includes a router and expert subnetworks that collaboratively handle the solution space,. The hypernetwork is responsible for generating the target network parameters, while the MoE module aids in efficiently dividing the solution space among experts. Unlike the hard domain configuration, the soft domain approach allows for a more flexible representation of the solution space and integrates physics-informed constraints, such as initial and boundary conditions, as penalties in the loss function. This approach balances computational efficiency and solution accuracy, making it particularly suitable for problems where approximate solutions are acceptable, such as early-stage training, real-time predictions, or problems with smooth solutions.

In short, the configuration in FIG. 5 (hard domain) is optimal for problems requiring localized precision and strict physics constraint enforcement, while the configuration in FIG. 6 (soft domain) is better suited for problems where computational efficiency and flexibility in solution representation are prioritized. The choice between these configurations depends on the specific requirements of the problem domain, enabling the PINO framework to address a wide variety of use cases effectively.

As will be appreciated by those skilled in the art, the techniques described in the various embodiments discussed above are not routine, or conventional, or well understood in the art. The techniques discussed above provide for innovative solutions to address the challenges associated with training the PINOs. The disclosed techniques offer several distinct advantages:

Firstly, the use of a dual hypernetwork module and low-rank domain decomposition, as illustrated in FIG. 5, ensures precise domain partitioning and accurate modeling of localized solution behaviors, enabling the effective handling of discontinuities, sharp gradients, and complex boundary conditions. This results in enhanced accuracy and robustness, particularly for problems with highly intricate or high-dimensional PDEs.

Secondly, the incorporation of a Mixture of Experts (MoE) framework, as depicted in FIG. 6, allows for a flexible representation of the solution space by dynamically allocating computational resources to different expert subnetworks based on the characteristics of the problem. This promotes computational efficiency without sacrificing solution fidelity, making the approach well-suited for real-time predictions or early-stage model training.

Additionally, the integration of physics constraints, such as initial and boundary conditions, as penalties within the loss function ensures that the PINOs not only learn the underlying physics but also adhere to them throughout the solution space. This feature enhances generalization and ensures physically meaningful predictions.

The methods disclosed also simplify the training process by balancing precision and computational efficiency, reducing the need for manual interventions or problem-specific adjustments. Furthermore, the flexibility to switch between hard and soft domain approaches based on the problem requirements provides a versatile framework that can address a wide range of applications, from localized precision tasks to smooth solution approximations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented method for training physics-informed neural operator (PINO) with a dual hypernetwork module and low-rank domain decomposition, comprising:
identifying an availability of information related to a system behavior and geometry complexity;
dynamically determining a training strategy for the PINO based on the identification, wherein the training strategy comprises selectively implementing at least one of:
a soft domain decomposition process, or
a hard domain decomposition process for training the PINO;
determining whether a size of a hypernetwork output layer exceeds a first predefined threshold;
if the size does not exceed the first predefined threshold, generating a set of training points across each domain;
iteratively training the PINO using one of the determined training strategy based on the set of training points until an error falls below a second predefined threshold; and
storing a trained model of the PINO with an associated set of parameters in a database when the error falls below the second predefined threshold after the iterative training.

2. The computer-implemented method of claim 1, wherein the soft domain decomposition process is implemented using a mixture of experts (MoE) approach.

3. The computer-implemented method of claim 1, wherein the hard domain decomposition process is implemented using the dual hypernetwork module and the low-rank domain decomposition (LoRA) technique.

4. The computer-implemented method of claim 3, wherein the dual hypernetwork module comprises
a first hypernetwork configured to co-learn about unknown solution operator for a complex partial differential equation (PDE) system; and
a second hypernetwork configured to embed sub-domain information and map the embedded sub-domain information to a feature representation for domain decomposition.

5. The computer-implemented method of claim 1, wherein if the size of the hypernetwork output layer exceeds the first predefined threshold, reducing the size of the hypernetwork outer layer using a chunked hypernetwork strategy.

6. The computer-implemented method of claim 1, wherein if the error does not fall below the second predefined threshold,
decomposing the domain into a plurality of finer sub-domains; and
reinitiating the training with the plurality of finer sub-domains in response to a previous iteration.

7. The computer-implemented method of claim 1, wherein the set of training points comprises initial points, boundary points, collocation points for enforcing physics-informed constraints, and interface points between adjacent sub-domains for maintaining physical continuity.

8. The computer-implemented method of claim 1, wherein dynamically determining the training strategy comprises:
initializing the training with the soft domain decomposition process when there is no prior availability of information related to the system behavior and geometry complexity.

9. The computer-implemented method of claim 8, wherein dynamically determining the training strategy further comprises:
reinitializing the training with the hard domain decomposition process in response to unsatisfactory results obtained during the soft domain decomposition process.

10. The computer-implemented method of claim 1, wherein implementing the hard domain decomposition process further comprises:
identifying a presence of at least one discontinuity and nonlinearity in the system, wherein identification of the presence is at least one of a successful identification or an unsuccessful identification.

11. The computer-implemented method of claim 10, further comprising:
performing at least one of,
upon the successful identification of the at least one discontinuity and nonlinearity, decomposing the domain into a plurality of finer sub-domains, or
upon the unsuccessful identification of the at least one discontinuity and nonlinearity, decomposing the domain into a plurality of coarser sub-domains.

12. The computer-implemented method of claim 11, further comprising:
determining at least one irregular geometry and non-uniform sub-domain configuration; and
generating one or more additional interface points and interface loss terms using an Extended Physics-Informed Neural Network (XPINN) in response to the at least one determined irregular geometry and non-uniform sub-domain configuration to maintain sub-domain continuity.

13. The computer-implemented method of claim 12, wherein upon unsuccessful determination of the at least one irregular geometry and non-uniform sub-domain configuration,
automatically maintaining the sub-domain continuity using a Finite Basis Physics-Informed Neural Network (FBPINN).

14. The computer-implemented method of claim 1, wherein implementing the soft domain decomposition process further comprises initializing a router module to manage interactions among one or more expert subnetworks.

15. A computer system for training physics-informed neural operator (PINO) with a dual hypernetwork module and low-rank domain decomposition, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
identifying an availability of information related to a system behavior and geometry complexity;
dynamically determining a training strategy for the PINO based on the identification, wherein the training strategy comprises selectively implementing at least one of:
a soft domain decomposition process, or
a hard domain decomposition process for training the PINO;
determining whether a size of a hypernetwork output layer exceeds a first predefined threshold;
if the size does not exceed the first predefined threshold, generating a set of training points across each domain;
iteratively training the PINO using one of the determined training strategy based on the set of training points until an error falls below a second predefined threshold; and
storing a trained model of the PINO with an associated set of parameters in a database when the error falls below the second predefined threshold after the iterative training.

16. The computer system of claim 15, wherein the hard domain decomposition process is implemented using the dual hypernetwork module and the low-rank domain decomposition (LoRA) technique, and wherein the dual hypernetwork module comprises
a first hypernetwork configured to co-learn about unknown solution operator for a complex partial differential equation (PDE) system; and
a second hypernetwork configured to embed sub-domain information and map the embedded sub-domain information to a feature representation for domain decomposition.

17. The computer system of claim 15, wherein if the error does not fall below the second predefined threshold,
decomposing the domain into a plurality of finer sub-domains; and
reinitiating the training with the plurality of finer sub-domains in response to a previous iteration.

18. The computer system of claim 15, wherein the set of training points comprises initial points, boundary points, collocation points for enforcing physics-informed constraints, and interface points between adjacent sub-domains for maintaining physical continuity.

19. The computer system of claim 15, wherein dynamically determining the training strategy comprises:
initializing the training with the soft domain decomposition process when there is no prior availability of information related to the system behavior and geometry complexity; and
reinitializing the training with the hard domain decomposition process in response to unsatisfactory results obtained during the soft domain decomposition process.

20. A non-transitory computer-readable storage medium having stored thereon computer executable instruction which when executed by one or more processors, cause the one or more processors to carry out operations for training physics-informed neural operator (PINO) with a dual hypernetwork module and low-rank domain decomposition, the operations comprising perform the operations comprising:
identifying an availability of information related to a system behavior and geometry complexity;
dynamically determining a training strategy for the PINO based on the identification, wherein the training strategy comprises selectively implementing at least one of:
a soft domain decomposition process, or
a hard domain decomposition process for training the PINO;
determining whether a size of a hypernetwork output layer exceeds a first predefined threshold;
if the size does not exceed the first predefined threshold, generating a set of training points across each domain;
iteratively training the PINO using one of the determined training strategy based on the set of training points until an error falls below a second predefined threshold; and
storing a trained model of the PINO with an associated set of parameters in a database when the error falls below the second predefined threshold after the iterative training.
